(19) United States
(12) Patent Application Publication
(10) Pub. No.: US 2024/0140147 A1
(43) Pub. Date: May 2, 2024

(54) TIRE ABNORMALITY DETECTION DEVICE FOR A LIGHT RAIL WITH RUBBER WHEELS

(71) Applicant: Kumho Tire Co., Inc., Gwangju (KR)

(72) Inventor: Dong Min YANG, Yongin-si (KR)

(21) Appl. No.: 18/086,901

(22) Filed: Dec. 22, 2022

(30) Foreign Application Priority Data
Nov. 2, 2022 (KR) 10-2022-0144144

(51) Int. Cl. B60C 23/06; G01L 1/16

(52) U.S. Cl. CPC B60C 23/063; G01L 1/16

(57) ABSTRACT

The present invention provides a device for detecting an abnormality in a tire for a light rail with rubber wheels. The detection device is installed inside the auxiliary rim, which is a rigid body mounted on an outer circumferential surface of a wheel, in a rubber tire body, and a protrusion part forming a detection unit of the detection device is configured to protrude into a space inside the rubber tire body. When the tire is punctured, the inner circumferential surface of the rubber tire body comes into close contact with the auxiliary rim, and the protrusion part is pushed into the auxiliary rim to touch the piezoelectric element of the detection unit and generate an electric signal, and thereby transmit a signal for indicating an abnormal condition of the tire to a controller.

### CROSS REFERENCE TO RELATED APPLICATIONS

This application claims the priority benefit of Korean Patent Application No. 10-2022-0144144 filed on Nov. 2, 2022, the entirety of which is incorporated by reference herein.

### GOVERNMENT RIGHTS

The present invention has been completed on the basis of the results of the development and demonstration of a high-performance and high-durability tire for a light rail, which was carried out as a part of the high-performance and high-durability tire for a light rail and safety-enhanced health monitoring technology development project of the Korea Agency for Infrastructure Technology Advancement under the Ministry of Land, Infrastructure and Transport of the Republic of Korea, wherein the results were obtained by performing tasks from Jan. 1, 2022 in KUMHO TIRE CO., INC. The contribution rate of KUMHO TIRE CO., INC. is 1/1, the task identification number is 1615012887, and the task number is 156026.

### BACKGROUND OF THE INVENTION

### 1. Field of the Invention

The present invention relates to a device for detecting an abnormality in a tire for a light rail with rubber wheels, and more particularly, to a device for detecting a decrease in an interval between an auxiliary rim and an inside of a tire due to a damage of the tire or a decrease in an air pressure thereof.

### 2. Description of the Related Art

In a light rail which uses rubber wheels among lightweight rails (hereinafter referred to as “light rails”), when the tire is damaged or an air pressure inside the tire is lower than a normal level due to long-time driving, the tire may be damaged due to an excessive increase in the temperature, and an increase in the bending and stretching amount.

When the tire does not function normally due to a damage, etc., some light rails with rubber wheels are equipped with auxiliary rims that wrap around the wheels to function instead of the tire so that the light rail can continue to operate.

Even if the light rail is equipped with a safety device such as auxiliary rims, for the safety of passengers, maintenance should be performed as soon as possible when the tire is damaged. Therefore, it is very important to immediately detect an abnormal condition of the tire.

However, it is difficult to mount a tire pressure monitoring system (TPMS), which is a device for measuring an air pressure inside the tire, on the tire for a currently running light rail with rubber wheels for structural reasons. Therefore, since the abnormal condition of the tire is detected by visually checking the condition of the tire or by detecting it through equipment installed in a certain section, it is difficult to respond immediately to the abnormality, and thereby it depends only on the durability of the auxiliary rim in the case of an emergency.

FIG. 6 is a cross-sectional view illustrating a conventional device for measuring internal air pressure of a tire for a light rail with rubber wheels. In order to maintain driving to some extent even in an emergency situation such as a significant decrease in the internal pressure of a rubber tire body 1 and a puncture, etc., an auxiliary rim 5 is installed on an outer circumferential surface 3 of a wheel 2 in an inner space 4 of the rubber tire body 1, to which air is filled.

However, there is a limitation in relying on the auxiliary rim 5 for driving when the function of the rubber tire body 1 is reduced or lost. That is, due to the imbalance of outer diameters between left and right wheels of a train, a great risk arises when driving at high speed. Therefore, when the internal pressure is reduced or a puncture of the rubber tire body 1 occurs, as shown in FIG. 6, in order to immediately confirm by a train driver or a control team at the train garage so as to take necessary actions, an air pressure sensor 7 (TPMS) is mounted on an inner circumferential surface 6 of the rubber tire body 1. When a change in the air pressure occurs, the air pressure sensor 7 detects and sends it to the driver for warning so as to take actions.

However, in the above-described warning method, the auxiliary rim 5 is fixedly installed to the outer circumferential surface 3 of the wheel 2 inside the rubber tire body 1. At this time, since the outer diameter of the auxiliary rim 5 is installed to have a height that does not differ much from the height of the tire in a normal condition, an interval between an outer circumferential surface 5a of the auxiliary rim 5 and the inner circumferential surface 6 of the rubber tire body 1 is reduced about 10 mm or less, and air is leaked from the rubber tire body 1 to reduce a volume of the inner space 4. Thereby, the air pressure sensor 7 comes into close contact with the outer circumferential surface 5a of the auxiliary rim 5, which is a rigid body, and is damaged, thereby resulting in poor durability of the air pressure detection device. In particular, since the air pressure sensor 7 is attached according to the curved shape of the inner circumferential surface 6 of the tire, a lower portion of the rubber tire body 1 made of flexible material that contacts a rail surface becomes indented due to a load of the train (if air is leaked, indention becomes more severe). In this case, in the process that the indented portion continues to change in a circumferential direction along with the rotation of the wheel, when an impact is continuously applied to the air pressure sensor 7 fixedly mounted on the inner circumferential surface 6 of the rubber tire body 1, the air pressure sensor 7 is detached or the durability is decreased. Therefore, it is urgent to improve these problems. As another problem, when replacing the used rubber tire due to wear or damage, the air pressure sensor 7 is also discarded, and since it can only be replaced with a rubber tire equipped with the air pressure sensor 7, resources are wasted, and maintenance efficiency is reduced.

Meanwhile, Korean Patent Laid-Open Publication No. 10-2022-0093963 (Patent Document 1) proposes a device for monitoring condition of wheels for a light rail using energy harvesting.

The Patent Document 1 introduces a monitoring device including: an energy harvester mounted on a wheel for a light rail and configured to collect energy generated due to a change in the distance between an auxiliary rim and the inner side of the tire, which is caused by the wheel as the train moves; a power management unit configured to convert the collected energy into an electrical energy and store it; a sensor operated with the converted electrical energy and configured to collect condition information on the wheels for a light rail; and a wireless communication unit operated with the converted electrical energy and configured to transmit the collected condition information to a management system. Therefore, by harvesting the energy generated due to the change in the distance between the auxiliary rim of the wheel for a light rail and the inside of the tire, it is possible to maintain stability, security, and sustainability of energy supply, and reduce environmental pollution.

However, in the device for monitoring a condition of wheels for a light rail disclosed in Patent Document 1, as shown in FIG. 7, a magnetic body 315 is attached to an auxiliary rim 314 and a coil 311 is attached to the inner surface of a tire 313, thereby collecting the induced voltage 312 generated by a change in the magnetic field generated by the coil 311 through a change in a distance 301 between the magnetic body 315 and the coil 311, and converting the collected induced voltage 312 to be usable through a power management circuit and storing it, which will be used as a power source for sensors and wireless modules. Therefore, not only the structure is very complicated, but also the magnetic field acting between the magnet and the coil significantly reduces even if the distance is increased by a little. In addition, as described above, there are problems in that the coil 311 mounted on the inner surface of the flexible rubber tire body may be detached due to the impact force repeatedly applied while the tire is repeatedly dented and returned to an original shape, and the useful life-span is shortened due to the reduced durability. Therefore, the above device is also not suitable as an effective means for detecting the tire pressure. As another problem, when replacing the used rubber tire due to wear or damage, the coil 311 is also discarded, and since it can only be replaced with a rubber tire equipped with the coil 311, resources are wasted, and maintenance efficiency is reduced.

### PRIOR ART DOCUMENT

### Patent Document

(Patent Document 1) Korean Patent Laid-Open Publication No. 10-2022-0093963
(Patent Document 2) Korean Patent Laid-Open Publication No. 10-2014-0067431
(Patent Document 3) U.S. Pat. No. 9,908,374

### SUMMARY OF THE INVENTION

In consideration of the above-mentioned circumstances, it is an object of the present invention to provide a device which immediately detects an abnormality when an inner side of a tire for a light rail with rubber wheels comes into contact with an auxiliary rim due to an abnormal condition of the tire.

In addition, another object of the present invention is to provide a device which wirelessly transmits the detection result of an abnormal condition to a communication equipment installed in a train.

Further, another object of the present invention is to provide a detection device having a structure which is not affected by a deformation of a rubber tire and is not damaged or detached when an inner side of the tire contacts an auxiliary rim.

Furthermore, another object of the present invention is to provide a detection device which is not discarded together even when the used rubber tires are replaced due to wear or damage of rubber tires, as well as may be repeatedly used for a long period of time without replacement, which is economical, and may be freely replaced with simple rubber tires, which is easy to perform maintenance, while being operated with low power.

To achieve the above objects, according to an aspect of the present invention, there is provided a device for detecting an abnormal condition of a tire for a light rail with rubber wheels, which includes a wheel, a rubber tire body mounted on an outer circumferential surface of the wheel to form a space therein, to which air is filled, and a rigid auxiliary rim mounted on the outer circumferential surface of the wheel, the device including: a detection unit which includes a protrusion part installed inside the auxiliary rim and a portion of a body thereof protruding into a space of the rubber tire body, and a piezoelectric element disposed to face the protrusion part and configured to generate an electrical signal when the protrusion part is pressed toward the inside of the auxiliary rim by a pressing force in contact with an inner circumferential surface of the rubber tire body; a controller configured to process the signal generated by the detection unit and control an operation of the device; a transmission unit configured to transmit a detection result of the controller to an outside; and a power unit configured to supply a power to the controller and transmission unit for operation thereof. The protrusion part may include a rod-shaped structure which protrudes into a space between the auxiliary rim and the inner circumferential surface of the rubber tire body and is pushed into the auxiliary rim due to the pressing force received when the inner circumferential surface of the rubber tire body contacts the auxiliary rim.

The detection unit may include the piezoelectric element which generates electric energy due to the applied pressing force when the protrusion part is pressed against the piezoelectric element by the inner circumferential surface of the rubber tire body.

The controller may collect the electric energy generated by the detection unit and determine whether the tire is in an abnormal condition based on the collected energy and transfer the detection result to the transmission unit for transmission to the outside of the detection device.

The controller and transmission unit may be configured to wake-up and operate only when the electric energy is generated by contacting the protrusion part of the detection unit with the piezoelectric element, and switch to a sleep mode to consume only minimal power when a signal is not received from the detection unit for a predetermined period of time.

When a detection signal is continuously input more than a predetermined number of times during a predetermined period of time from the detection unit, the controller may determine that there is a tire failure and control the transmission unit to notify the driver's room or situation control room of the tire failure.

In a preferred embodiment, the protrusion part may have a piston shape and one end thereof may be accommodated in a housing installed inside the auxiliary rim body, wherein one end of the protrusion part accommodated in the housing may be elastically supported by an elastic body.

A compression coil spring or urethane rubber having an elastic restoring force by compression may be used as the elastic body.

One end of the elastic body may be supported by a circuit board, the piezoelectric element of the detection unit may be installed to be mounted on the circuit board, and the controller and transmission unit may be provided on the circuit board.

In addition, a battery may be accommodated and installed as a power unit inside the housing on a rear of the circuit board.

Further, the protrusion part may be designed to adjust a protruding length in consideration of an allowable minimum pressure of the tire.

Herein, the protrusion part may be screwed with a cylindrical connection member forming a base portion to adjust the protruding length according to the direction of rotation.

According to the present invention, the detection device may immediately detect a decrease in an interval between the auxiliary rim and the inner side of the tire in a light rail with rubber wheels, such that when an abnormal condition occurs in the tire, actions may be taken as quickly as possible. In addition, since only a portion of the protrusion part, not the entire detection device, is present between the auxiliary rim and the inside of the tire, main components of the detection device may be protected by the housing inside the auxiliary rim even when the abnormal condition occurs, thereby being operated, and maintained normally without damage. Therefore, when replacing the rubber tire portion, the detection device may be repeatedly used, and the abnormal condition may be detected with low power through the piezoelectric element of the detection unit protected by the housing.

### BRIEF DESCRIPTION OF THE DRAWINGS

The above and other objects, features and other advantages of the present invention will be more clearly understood from the following detailed description taken in conjunction with the accompanying drawings, in which:

FIG. 1A and FIG. 1B are a perspective view and a cross-sectional view, respectively, schematically illustrating a state in which a device for detecting an abnormal condition of a tire according to the present invention is installed on the tire for a light rail with rubber wheels;

FIG. 2A and FIG. 2B are a cross-sectional view and an enlarged view, respectively, illustrating the detailed structure and installation position of main parts in the device for detecting an abnormal condition of a tire according to the present invention;

FIG. 3A and FIG. 3B are cross-sectional views illustrating a decrease in an interval between an auxiliary rim and an inner side of the tire and a change in the detection device according thereto when the tire is in a normal condition and an abnormal condition, respectively;

FIG. 4 is a cross-sectional view illustrating one embodiment of a method of adjusting a length of a protrusion part of the present invention;

FIG. 5 is a block diagram illustrating control in an entire system of the present invention;

FIG. 6 is a cross-sectional view of a tire illustrating a state in which a conventional air pressure detection device is installed in a tire for a light rail with rubber wheels; and

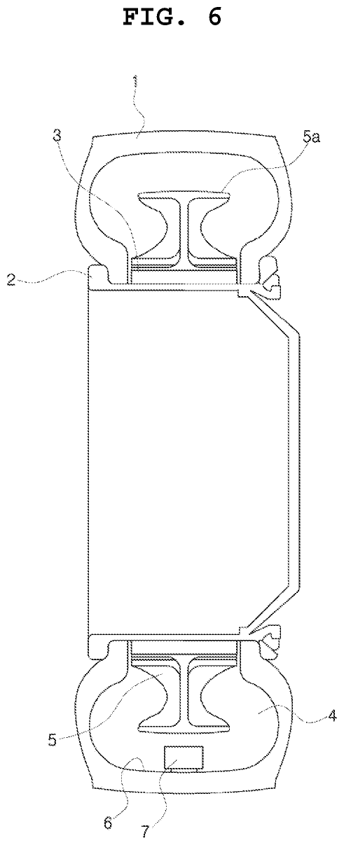

FIG. 7 is a cross-sectional view of a tire illustrating another conventional device for monitoring conditions in a wheel for a light rail.

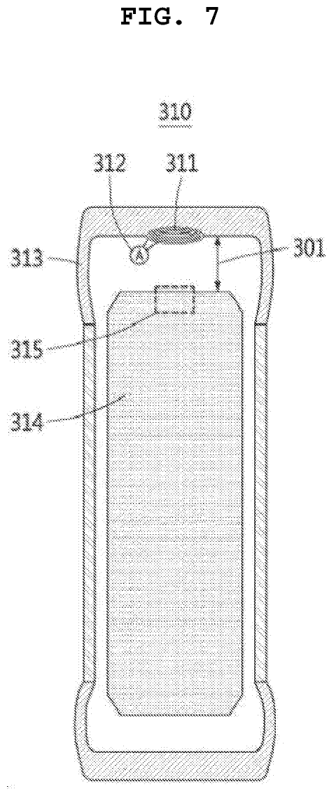

### DETAILED DESCRIPTION OF THE INVENTION

Hereinafter, preferred embodiments of the present invention will be described in detail with reference to the accompanying drawings, so that persons having common knowledge in the technical field to which the present invention pertains may easily implement the invention.

However, since the description of the present invention is only an embodiment for structural or functional description, the scope of the present invention should not be construed as being limited by the embodiments described in the present disclosure.

For example, since the embodiments may be changed and have various forms, it should be understood that the scope of the present invention includes equivalents capable of realizing the technical idea.

In addition, the objects or effects presented in the present invention do not mean that a specific embodiment should include all of them or only such effects, such that it should be understood that the scope of the present invention is not limited thereto.

In the present specification, the embodiments are provided to make the disclosure of the present invention complete, and to completely inform those skilled in the art to which the present invention pertains of the scope of the invention. In addition, the present invention is only defined by the scope of the claims.

Thus, in some embodiments, well-known components, well-known operations and well-known techniques will not be described in detail in order to avoid obscuring the interpretation of the present invention.

Meanwhile, the meaning of the terms described in the present invention is not limited to the lexical meaning, and the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Accordingly, all terms used herein have the same meaning as commonly understood by those skilled in the art to which the present invention pertains, unless defined otherwise.

Terms defined in commonly used dictionaries should be interpreted as being consistent with meanings in the context of the related art, and unless explicitly defined in the present invention, they cannot be interpreted as having ideal or excessively formal meanings.

Hereinafter, embodiments of the present invention will be described in detail with reference to the drawings. In the description of the embodiments, the same reference numerals are denoted to the same components, and the same reference numerals will not be described in some cases.

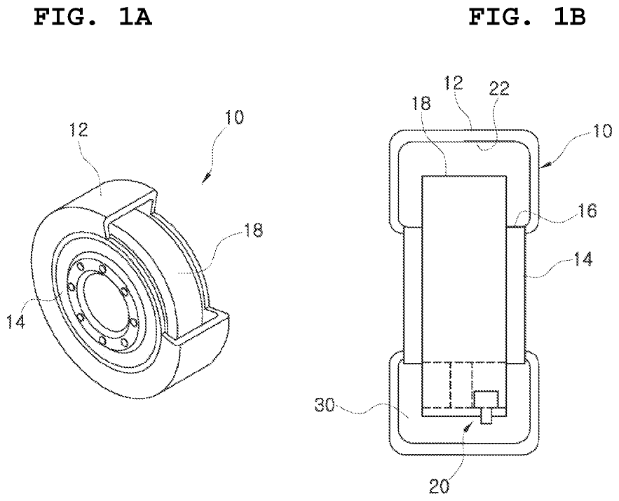

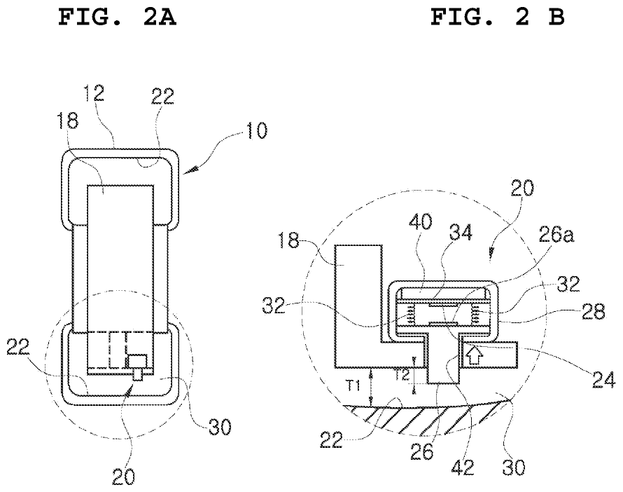

FIG. 1A and FIG. 1B are a perspective view and a cross-sectional view, respectively, schematically illustrating a state in which a device for detecting an abnormal condition of a tire according to the present invention is installed on the tire for a light rail with rubber wheels, and FIG. 2A and FIG. 2B are a cross-sectional view and an enlarged view, respectively, illustrating the detailed structure and installation position of main parts in the device for detecting an abnormal condition of a tire according to the present invention. Herein, the tire of the present invention is generally indicated by reference numeral 10.

The tire 10 of the present invention includes a rubber tire body 12, a wheel 14 which maintains and supports the rubber tire body 12, and an auxiliary rim 18 (or auxiliary wheel) mounted on an outer circumferential surface 16 of the wheel 14 in a space 30 in the rubber tire body 12, to which air is filled. A detection device 20 of the present invention is installed on the auxiliary rim 18 made of a metal material, and the installation location of the detection device 20 may be selected to be easily installed and maintained.

As shown in the enlarged view of FIG. 2A (FIG. 2B), the detection device 20 includes a detection unit 25 (24 and 26) reacted by a decrease in an interval T1 between the auxiliary rim 18 and an inner circumferential surface 22 of the rubber tire body 12, and may include, for example, a piezoelectric element 24 configured to detect a pressing force when a contact force is received, and a protrusion part 26 which comes into contact with the piezoelectric element 24 to press the same. The protrusion part 26 has a piston shape accommodated in a housing 28 installed inside a body of the auxiliary rim 18, and a portion of the body thereof penetrates the housing 28 and protrudes into the space 30 inside the rubber tire body 12 by a predetermined length T2. When the space 30 is reduced due to a rapid drop in the internal pressure of the tire 10, the protrusion part 26 may receive contact pressure by the inner circumferential surface 22 of the indented rubber tire body 12, so as to move backward. To this end, the protrusion part 26 is installed so as to be supported by an elastic body 32 accommodated in the housing 28. In this case, a compression spring or urethane rubber having an elastic restoring force while being reduced in volume by the action of a compressive force is used as the elastic body 32. Herein, the protruding length T2 of the protrusion part 26 is designed in consideration of the allowable minimum pressure of the tire 10.

A circuit board 34 is disposed on a rear of the elastic body 32, such that the elastic body 32 may be installed to be supported by the circuit board 34 or directly supported by an inner wall surface of the housing 28.

The piezoelectric element 24 of the detection unit 25 is mounted on the circuit board 34, and a controller 36 configured to control an operation of the device is mounted on the circuit board 34 to form a circuit. When the protrusion part 26 forming the detection unit 25 applies a pressing force to the piezoelectric element 24, the piezoelectric element 24 converts the force into an electrical signal and outputs it. When the electrical signal converted by the piezoelectric element 24 of the detection unit 25 is transmitted to the controller 36, the controller 36 determines whether it is an abnormal condition, and transmits a detection result to a driver or a control center in the case of the abnormal condition. To this end, the circuit board 34 includes a transmission unit 38 configured to transmit the detection result from the controller 36 to an outside of the detection device 20, and further includes a power unit 40 configured to supply a power to the detection device 20. The power unit 40 is a battery that stores electricity, and is installed in the inner space of the housing 28 on the rear of the circuit board 34.

It is necessary to prevent the detection device 20 from being damaged even when the inner circumferential surface 22 side of the rubber tire body 12 comes into contact with the auxiliary rim 18 due to an abnormality occurring in the tire 10. To this end, the body of the housing 28 is located inside the auxiliary rim 18, and only the protrusion part 26 of the detection device 20 should be installed in the space 30 between the auxiliary rim 18 and the inner side of the rubber tire body 12.

As a method of installing the detection device 20, a method of fixing the housing 28 of the detection device 20 and the auxiliary rim 18 through screws or bolts or attaching them using an adhesive may be used.

Before installing the detection device 20, a hole 42 should be drilled in the auxiliary rim 18 to secure a space for the protrusion part 26 so that the protrusion part 26 of the detection unit 25 is located in the space 30 between the auxiliary rim 18 and the inner circumferential surface 22 of the rubber tire body 12.

As shown in FIG. 2A and FIG. 2B, the detection device 20 should be fixed so as to receive the maximum force in a vertical direction when a pressing force is applied to the detection unit 25 by the inner circumferential surface 22 of the rubber tire body 12.

The protrusion part 26 of the detection unit 25 of the detection device 20 includes a rod-shaped structure (hereinafter, referred to as “an adjuster 26b”) protruding to an outside of the detection device 20. The protrusion part 26 is configured to be fixedly and elastically supported by the elastic body 32 (hereinafter referred to as “a spring”) inside the detection device 20. When the protrusion part 26 moves due to simple vibration or gravity, which is not an abnormal condition of the tire, the spring 32 secures a separation distance sufficient to absorb it to some extent, thereby preventing the protrusion part 26 of the detection unit 25 from coming into contact with the piezoelectric element 24. Therefore, it is important to prevent the detection device 20 from erroneously determining that the tire 10 is in an abnormal condition even when the tire 10 is in a normal condition.

For this reason, it should be designed considering the separation distance between the protrusion part 26 and the circuit board 34 so that components including the circuit board 34 inside the detection device 20 are not damaged, when the inner circumferential surface 22 of the rubber tire body 12 completely contacts the auxiliary rim 18 and the protrusion part 26 of the detection unit 25 is pressed into the detection device 20 to the maximum.

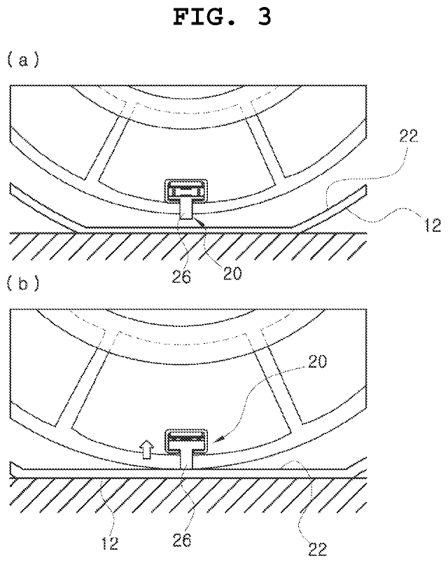

FIGS. 3(a) and (b) are cross-sectional views illustrating a decrease in the interval between the auxiliary rim and the inside of the tire and a change in the detection device according thereto when the tire is in a normal condition and an abnormal condition, respectively. When the tire 10 is in a normal condition, even if the rubber tire body 12 becomes indented by a load of the train, the inner circumferential surface 22 of the rubber tire body 12 does not directly contact the protrusion part 26 of the detection device 20, such that there is no signal detected by the piezoelectric element 24. On the other hand, when the air in the space 30 is released to the outside due to an abnormal condition of the tire 10, for example, a puncture, and the tire 10 becomes indented and the inner circumferential surface 22 is completely adhered to the auxiliary rim 18, the protrusion part 26 is inserted and accommodated in the housing 28 while compressing the spring 32. In this state, the protrusion part 26 touches the piezoelectric element 24, and the detection unit 25 outputs a signal indicating that an abnormality has occurred in the tire to the controller 36. At this time, in order to improve contact with the piezoelectric element 24, a contact pressing member 26a of the protrusion part 26 protrudes from an upper portion (based on illustration) in consideration of the height of a body of the spring 32 in a compressed state, so as to reliably secure the contact with the piezoelectric element 24.

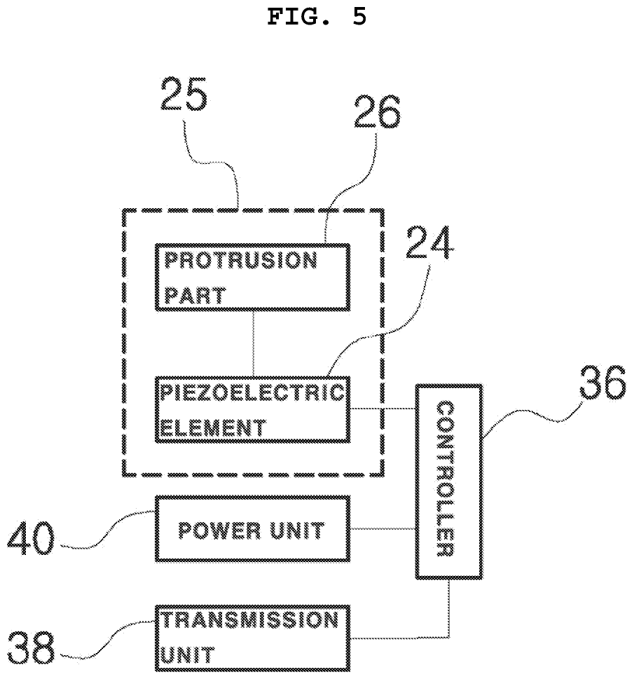

FIG. 5 is a block diagram illustrating control of the entire system of the present invention. When a signal is output from the piezoelectric element 24, power supply from the power unit 40 to the controller 36 and the transmission unit 38 is started. When an abnormal situation such as a puncture occurs in the tire 10 and the tire 10 becomes indented and the protrusion part 26 of the detection unit 25 comes into contact with the piezoelectric element 24, the pressing force received at this time is converted into an electrical signal and transmitted to the controller 36. The controller 36 determines whether there is a tire abnormal condition from the detected information and transmits a signal indicating that an abnormality has occurred to the train driver or the control center in the abnormal situation.

The controller 36 collects electrical signals of the piezoelectric element 24, and when signals are generated more than a predetermined number of times per minute, for example, 10 times or more per minute, determines that it is an abnormal condition and transmits the detection result to an outside through the transmission unit 38, that is, to the train driver or the central control center, etc. In accordance with the signal output from the transmission unit 38, a warning device, etc. is operated in the driver's room or control room to notify that there is abnormality in the tire 10, and according to such an alarm, the operator immediately checks whether the tire 10 is abnormal and repairs or replaces the tire if necessary.

Herein, even if the piezoelectric element 24 comes into contact with the protrusion part 26 once or several times and the signal is applied to the controller 36, it is not determined as an abnormality of the tire 10. The reason is that the protrusion part 26 may temporarily touch the piezoelectric element 24 due to swaying of the rubber tire body 12. When the detection signal is continuously input more than a predetermined number of times, for example, 10 times or more per minute, it is determined as the abnormal condition such as a tire puncture, such that an accuracy of abnormality determination is improved.

The controller 36 and the transmission unit 38 wake-up and operate only when electrical energy is generated in the piezoelectric element 24 of the detection unit 25. If no signal is received from the detection unit 25 for a predetermined period of time, for example, 10 minutes or more, it is preferable to switch to a sleep mode and consume minimal power.

The detection result from the detection unit 25 may include information on the generation time, the number of times of occurrence of the electrical signal, and the detection device.

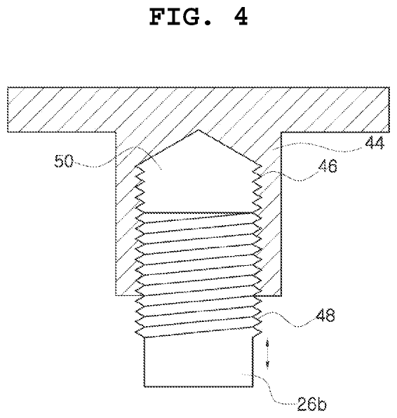

FIG. 4 is a cross-sectional view illustrating an embodiment of a method for adjusting a length of the protrusion part of the detection unit according to the present invention. The protrusion part 26 of the detection unit 25 includes a cylindrical connection member 44, which is a base portion supported by the spring 32, and the adjuster 26b fastened to the cylindrical connection member 44 by screws 46 and 48. Thus, when rotating the rotatable adjuster 26b with respect to the cylindrical connection member 44 in a loosening direction of the screws 46 and 48, the protruding length is increased, and when rotating the adjuster 26b in a tightening direction of the screws, the adjuster 26b is inserted into a space 50 of the cylindrical connection member 44 to reduce the protruding length. Therefore, it is possible to adjust the protruding degree of the adjuster 26b using the screw fastening principle.

Herein, the protruding degree of the adjuster 26b of the protrusion part 26 in the detection unit 25 is determined by calculating an interval required to detect the abnormal condition based on the degree of deformation of the tire due to the load, such as a size of the tire, size of the auxiliary wheel, and air pressure, etc.

Although preferred embodiments of the present invention have been described with reference to the accompanying drawings, the embodiments and drawings described and illustrated in the present disclosure are simply the most preferred embodiment and do not represent all the technical sprites of the present invention, and it will be understood that various modifications and equivalents may be made to take the place of the embodiments at the time of filling the present application. Thus, it is clear that the above-described embodiments are illustrative in all aspects and do not limit the present disclosure. The scope of the present disclosure is defined by the following claims rather than by the detailed description of the embodiment. It shall be understood that all modifications and embodiments conceived from the meaning and scope of the claims and their equivalents are included in the scope of the present disclosure.

### DESCRIPTION OF REFERENCE NUMERALS

10: Tire for a light rail with rubber wheels
12: Rubber tire body
14: Wheel
16: Outer circumferential surface of wheel
18: Auxiliary rim
20: Detection device
22: Inner circumferential surface of rubber tire body
24: Piezoelectric element
26: Protrusion part
26a: Contact pressing member
26b: Adjuster
25 (24, 26): Detection unit
28: Housing
30: Inner space
32: Elastic body (spring)
34: Circuit board
36: Controller
38: Transmission unit
40: Power unit (battery)
42: Hole
44: Cylindrical connection member (base portion)
46, 48: Screw (female thread, male thread)
T1: Interval between auxiliary rim and inner circumferential surface of rubber tire body
T2: Length of protrusion part

What is claimed is:

1. A device for detecting an abnormal condition of a tire for a light rail with rubber wheels, which comprises a wheel, a rubber tire body mounted on an outer circumferential surface of the wheel to form a space therein, to which air is filled, and a rigid auxiliary rim mounted on the outer circumferential surface of the wheel, the device comprising:
a detection unit which comprises a protrusion part installed inside the auxiliary rim and a portion of a body thereof protruding into a space of the rubber tire body, and a piezoelectric element disposed to face the protrusion part and configured to generate an electrical signal when the protrusion part is pressed toward the inside of the auxiliary rim by a pressing force in contact with an inner circumferential surface of the rubber tire body;
a controller configured to process the signal generated by the detection unit and control an operation of the device;
a transmission unit configured to transmit a detection result of the controller to an outside; and
a power unit configured to supply a power to the controller and transmission unit for operation thereof.

2. The device according to claim 1, wherein the protrusion part of the detection unit comprises a rod-shaped structure which protrudes into a space between the auxiliary rim and the inner circumferential surface of the rubber tire body, and is pushed into the auxiliary rim due to the pressing force received when the inner circumferential surface of the rubber tire body contacts the auxiliary rim.

3. The device according to claim 1, wherein the controller collects the electric energy generated by the detection unit, and determine whether the tire is in an abnormal condition based on the collected energy, and transfer the detection result to the transmission unit for transmission to the outside of the detection device.

4. The device according to claim 3, wherein the controller and transmission unit are configured to wake-up and operate only when the electric energy is generated by contacting the protrusion part of the detection unit with the piezoelectric element, and switch to a sleep mode to consume only minimal power when a signal is not received from the detection unit for a predetermined period of time.

5. The device according to claim 3, wherein, when a detection signal is continuously input more than a predetermined number of times during a predetermined period of time from the detection unit, the controller determines that there is a tire failure and control the transmission unit to notify the driver's room or situation control room of the tire failure.

6. The device according to claim 1, wherein the protrusion part has a piston shape and one end thereof is accommodated in a housing installed inside the auxiliary rim body, wherein one end of the protrusion part accommodated in the housing is elastically supported by an elastic body.
